(19) United States
(12) Patent Application Publication
(10) Pub. No.: US 2015/0107081 A1
(43) Pub. Date: Apr. 23, 2015

(54) ANGLED FASTENER DRIVING DEVICE

(71) Applicant: HALEX/SCOTT FETZER COMPANY, Bedford Heights, OH (US)

(72) Inventors: Brett A. Kasper, Stow, OH (US); Chad Long, Chagrin Falls, OH (US); John S. Crenshaw, Rock Creek, OH (US)

(73) Assignee: HALEX/SCOTT FETZER COMPANY, Bedford Heights, OH (US)

(21) Appl. No.: 14/517,227

(22) Filed: Oct. 17, 2014

Related U.S. Application Data
(60) Provisional application No. 61/893,192, filed on Oct. 19, 2013.

(51) Int. Cl. B25C 5/06; F16B 15/00

(52) U.S. Cl. CPC B25C 5/06; F16B 15/0015
USPC 29/432; 411/460; 227/148

(57) ABSTRACT

The present invention includes various embodiments directed to apparatus and methods surrounding a fastener driving device. In particular embodiments, the fastener driving device is a tool designed to drive fasteners into an associated work piece at an angle that includes at least a housing, seating member, magazine with fasteners and a striker. Other novel features of the fastener device exist. In particular embodiments, the present invention also includes apparatus and methods related to driving fasteners at predetermined, or adjustable, angles relative to a substantially planar work piece surface for securing cables and the like.

This application claims priority to, and the benefit of, U.S. Provisional Patent Application No. 61/893,192 filed on Oct. 19, 2013 with the United States Patent Office, which is hereby incorporated by reference.

### BACKGROUND OF THE INVENTION

1. Field of the Invention

Embodiments of the present invention relate to a device for driving staples and other fasteners into a work piece at predetermined—and in some embodiments, adjustable angles. More specifically, embodiments of the present invention relate to a portable, lightweight, hand-held device that utilizes a novel seating member and/or fasteners to drive staples into a work piece at an angle.

2. Description of the Related Art

Staplers and other fastener driving devices are well known in the art, but generally fall into two broad categories: manual or motor driven. Industrial or commercial-grade fastener driving devices must reliably, securely, and consistently drive the desired fasteners into more resistant (i.e., harder or denser) materials, such as, for example, wood, plastics, concrete, and composites thereof.

Staples are often used to secure wiring and the like in homes and commercial buildings to prevent the wiring from moving. Indeed, from time to time carpenters and electricians are required to secure cables and other wiring in structural locations of very limited space.

Accordingly, there remains a need to provide a fastener driving device and staples that meet the inadequacies and deficiencies in the prior art, including those identified above. The fastener driving device and staples disclosed herein provide novel solutions to these and other problems.

### SUMMARY OF THE INVENTION

Particular embodiments of the present invention include an apparatus and methods for discharging and driving fasteners into work pieces. Particular embodiments of the present invention include a method for driving fasteners into a work piece at an angle, comprising: providing a driving tool having: a fastener; a seating member adapted to position the fastener in a driving direction obliquely angled above a side of a work piece; and a striker adapted to drive said fastener into a work piece; positioning the seating member onto a work piece target zone at an angle; and applying driving forces to the striker to drive the fastener into the work piece.

Other particular embodiments of the present invention include a staple comprising a bight section, the bight section having a width extending between a pair of legs; and a pair of legs, the legs extending outwardly from an underside of the bight section at oblique angles.

Still other particular embodiments of the present invention include a fastener driving tool comprising: a housing; a seating member adapted to position fasteners at an angle above a substantially planar work piece; a magazine containing fasteners; and a striker adapted to forcibly separate fasteners from the magazine and drive said fastener into a work piece.

The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIG. 1 is a perspective view from the top and side of an exemplary embodiment of the fastener driving device or tool of the present invention.

FIG. 1a is a side perspective view of the housing and seating member shown in FIG. 1.

FIG. 2 is a front view of the driving tool of FIG. 1, in accordance with an embodiment of the present invention.

FIG. 3 is a perspective view, from the bottom and side, of the housing, seating member, projections, and gripping protrusions of the fastener driving device of FIG. 1, according to one embodiment of the present invention.

FIG. 4 is a side view of a fastener driving tool, in accordance with another embodiment of the present invention.

FIG. 5 is a side partial cross-sectional view of the device shown in FIG. 4, in accordance with an embodiment of the present invention.

FIG. 6 is a side view of a striker, striker guide and fastener, in accordance with an embodiment of the present invention.

FIG. 7 is a side view of a striker, striker guide and fastener, in accordance with another embodiment of the present invention.

FIG. 8 is a front view of the fastener driving tool, in accordance with another embodiment of the present invention.

FIG. 9 is a side view of the striker, striker guide, dial and fastener, in accordance with an embodiment of the present invention.

FIG. 10 is a side partial cross-sectional view of the fastener driving tool of FIG. 1, according to one embodiment of the present invention.

FIG. 11 is a perspective view of the depth adjustment mechanism, magazine, and striker guide in accordance with an embodiment of device disclosed in FIG. 10.

FIG. 12 is yet another perspective view of the depth adjustment mechanism, magazine, and striker guide in accordance with an embodiment of device disclosed in FIG. 10.

FIG. 13 is a cross-sectional view of the depth adjustment mechanism, in accordance with an embodiment of the device disclosed in FIG. 10.

FIG. 14 is a top view of the depth adjustment mechanism's dial, in accordance with an embodiment of the invention shown in FIG. 10.

FIG. 15 is a top view of the fastener driving tool of FIG. 1, in accordance with an embodiment of the present invention.

FIG. 16 is a partial perspective side view of the fastener driving tool of FIG. 1, in accordance with an embodiment of the present invention.

### DETAILED DESCRIPTION OF PARTICULAR EMBODIMENTS

A fastener driving tool is generally discussed herein that resolves known problems in the prior art. Namely, existing fastener driving devices, and their associated fasteners, are presently incapable of generating the leverage and driving forces necessary to adequately secure cables within work spaces of limited accessibility. Specifically, it is not uncommon for electricians to have to secure wiring in between wall studs that are spaced a mere four inches apart. Persons of ordinary skill in the art will appreciate that substantially vertical insertion of fasteners, particularly via manual actuation of the fastener driving tools, is impossible in existing devices because the driving tool cannot be situated in a position substantially perpendicular to the work piece, nor leave sufficient room for receipt of impact from a hammer. Moreover, existing driving tools are incapable of consistently and securely seating the driving tool at an oblique angle over a target zone, while existing fasteners are of a configuration that does not permit predictable and repeatable angled insertion into work pieces. In short, to effectively perform in real world conditions, existing driving tool devices would be improved so as to provide obliquely angled driving capabilities by incorporating arrangements of driving tool components, and related methods, as further disclosed herein.

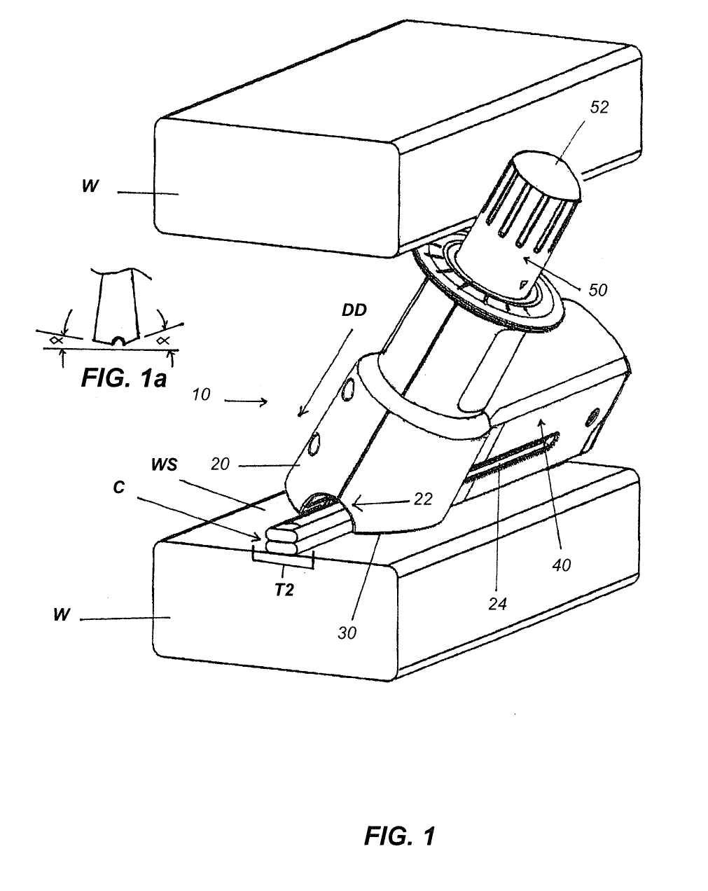

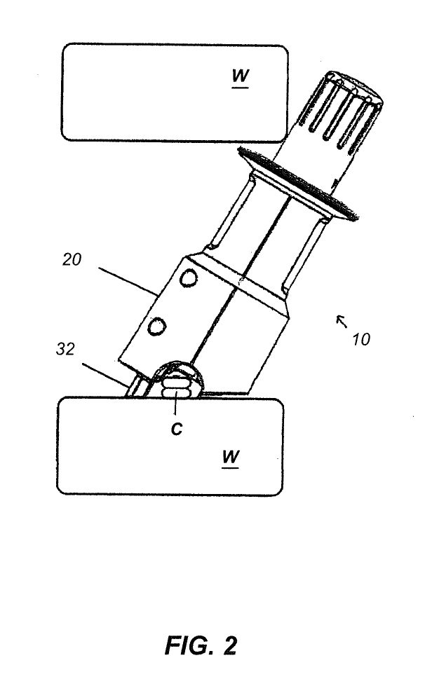

The fastener driving tool 10 of the present invention may operate from electric or gas-combustible power sources, but in most embodiments derives driving forces from manual operation. Device 10 may be a stapler, a nailer, a tacker or any other fastener driving device. Broadly speaking, the fastener driving tool 10 is capable of operatively discharging fasteners 100 into work pieces (W) having surfaces with limited accessibility, as is generally illustrated in FIGS. 1, 2, 4, 5, and 8. This functionality is achievable by provision of a stable and repeatable driving direction (DD) that—in contrast to prior art devices with a substantially vertical, or right angle, driving direction—is obliquely angled relative to the longitudinal plane of a side of a work piece. Further explanation of the device 10 components, and arrangement of components, will assist in better understanding the methods and devices detailed herein.

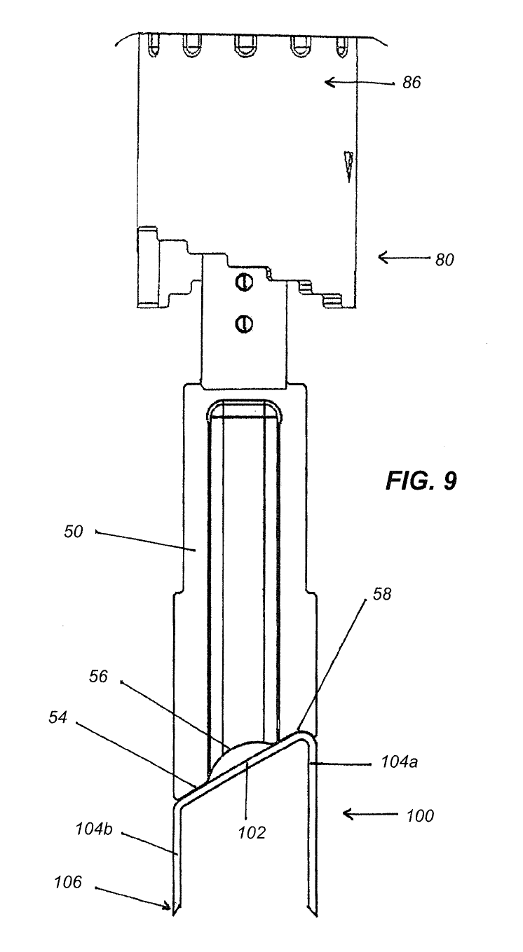

In exemplary embodiments, as shown in FIGS. 1-16, driving tool 10 may be a stapler comprising combinations including one or more of a housing 20, seating member 30, fastener magazine 40, striker 50 and other components as detailed herein. The housing 20 may be configured to operatively support various device 10 components, including, in various embodiments, a fastener magazine 40, striker 50, seating member 30, motor (not shown), pneumatic fittings and drive systems (not shown), and associated wiring and/or tubing (not shown).

With reference to FIGS. 1, 11, 12, and 16, a magazine 40 is generally shown configured to receive and operatively position a fastener 100, or a plurality of fasteners 100 comprising a strip of staples; the magazine 40 being positioned within the housing 20 so that the lead fastener is positioned in readiness for being forcibly stripped from the strip via impact from the striker 50, the striker 50 thereafter applying forces in a driving direction (DD) towards an outer side of the work piece (W) until the fastener 100 is driven to a satisfactory depth within the work piece. It is understood that the driven depth of the fastener into the work piece may correspond to either the force applied or as permitted by a stop member, for example. In particular embodiments, the fastener is a staple, but it is understood that the fastener may comprise any fastener to be driven such as a nail or brad. It is appreciated that the fasteners may be loaded and stored singly, or may be loaded and stored en masse, such as within a magazine, for example.

With reference now to the exemplary embodiments of FIGS. 5-8, in particular embodiments, the striker 50 is operatively seated within a striker guide 70 in a manner that assists in controlled reciprocating movement of the striker 50 between a resting position (RP) and a driving position (DP) which culminates in insertion of the fastener 100 into the desired target zone (TZ) of the work piece side (WS). Persons of ordinary skill in the art will appreciate that reciprocating movement of the striker 50 can be achieved by virtue of spring-biased components, or other similar functional mechanisms, well known in the art. It is also noted that the striker may be driven by any known means, such as by an actuator, a fly wheel, or a solenoid, for example. In the embodiments shown in FIGS. 1-16, however, the tool 10 comprises a manually operated tool, where the striker 50 additionally contains a hammer plate 52 designed to receive and transfer forces applied by a hammer (not shown) to the striker 50 in a manner that drives said fastener into the work piece (W).

As exemplarily shown in FIGS. 1-5, and 8, the driving tool of the present invention incorporates a seating member 30 designed and configured to engage a side of the work piece (WS) in a manner that positions fasteners 100 residing within the device housing 20 in a driving direction (DD) that is consistently canted or angled at an oblique angle or in an oblique position relative a side of the work piece (WS). The seating member 30 provides a point of contact for engaging the device 10 against the work piece target zone (TZ) for receipt of a discharged fastener 100; furthermore, the seating member 30 allows a user to forcefully direct the device 10 against the target zone (TZ) in anticipation of fastener discharge. It is appreciated that the driving tool discharges fasteners from the tool in a driving direction (DD) at any oblique angle relative the side of the work piece (WS) or target zone (TZ). For example, in particular embodiments, the seating member 30 positions the fasteners in a driving direction (DD), and is driven in a driving direction (DD), comprising an oblique angle of substantially forty (40) degrees relative to a side of the work piece (WS) or target zone (TZ). In other embodiments, however, the oblique driving direction (DD) angle is thirty (30) degrees, in the range of thirty (30) to thirty-nine (39) degrees, thirty (30) to forty (40) degrees, forty (40) to fifty (50) degrees, or between forty-one and fifty degrees (41 and 50 degrees). In still other embodiments, the oblique driving direction (DD) is be between zero (0) and ninety (90) degrees but not zero (0) or ninety (90) degrees, between one (1) and eighty-nine (89) degrees, between ninety (90) and one-hundred and eighty (180) degrees but not ninety (90) or one-hundred and eighty (180) degrees, or between ninety-one (91) and one hundred and seventy-nine (179) degrees. In each of these cases, in certain embodiments thereof, the, the work piece side (WS) is a substantially planar surface, although in other certain embodiments it is a non-planar surface.

It is appreciated that the seating members may be arranged at any location and may be incorporated in any manner within the tool. In particular embodiments, for example, with reference to FIGS. 1-5, the seating member 30 comprises a lower portion of the housing 20, wherein the housing 20 includes a clearance recess 22 designed to be seated around cabling (C) situated within the work piece target zone (TZ). The clearance recess 22 assists in centering the seating member 30 at the target zone (TZ) so as to align the cable to be secured between the legs of a discharging staple, or other fastener, and which may prevent any potential damage to the targeted cabling. In certain embodiments, as generally shown in FIGS. 1 and 1a, the clearance recess 22 may be centered to two seating member portions 30, both of which are configured to contact a longitudinal span of the work piece side (WS) depending on the placement of the driving tool (the driving tool can be flipped to either side for ambidextrous use, or as circumstances otherwise warrant).

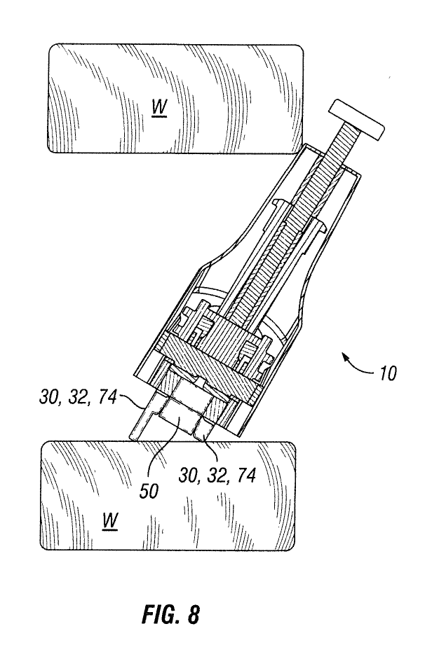

In still other embodiments, such as shown in FIG. 8 by example, the seating member 30 consists of a lower portion 74 of the striker guide 70. The guide may comprise any shape, but which may additionally comprise a clearance recess 72 in certain embodiments.

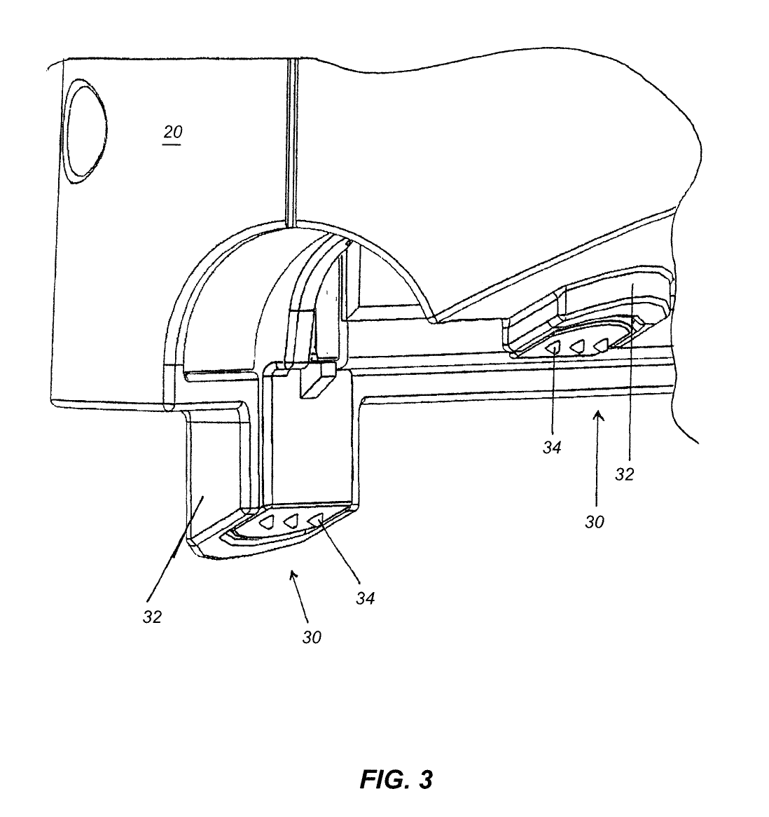

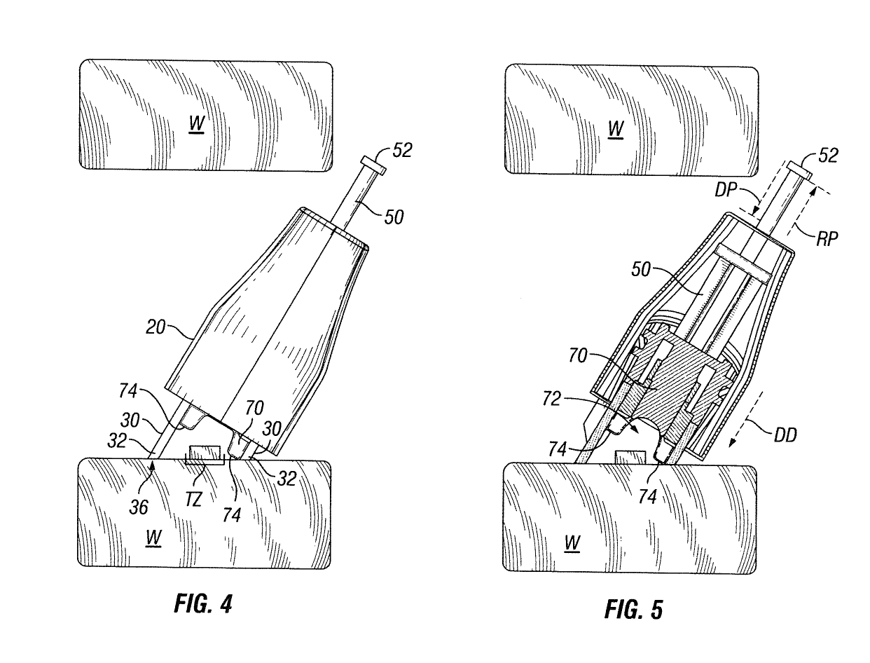

In other embodiments the seating member 30 may consist of one or more projections 32 either integral to, or supported by, the housing 20 and/or striker guide 70 (as shown in FIGS. 4 and 5), or any other structure associated with the device. The projections 32 may be adapted to simultaneously contact a side of the work piece (WS) at the target zone (TZ). The projections 32 may have tips 36 that are obliquely canted when seated on the target zone (TZ) so as to position fasteners 100 in a desired degree of angularity; particularly, a forty degree angle; or, any other oblique degree of angularity contemplated herein for a driving direction (DD). Still further, in some embodiments the seating member may have one or more gripping protrusions 34, as shown in FIG. 3, adapted to grip the work piece side (WS) during the driving operation. In some embodiments, the seating member 30, and/or one or more of the projections 32, may be adjustable to alter the angle of the driving direction (DD). Adjustability may comprise changing the length of one or both seating members, or by removing and replacing one or both seating members with differently sized or biased seating members.

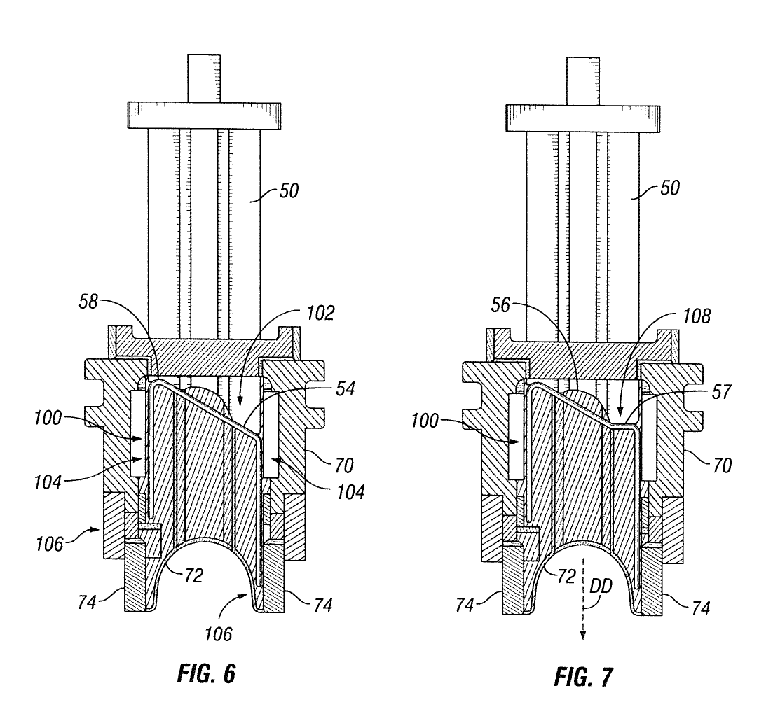

The role of seating member 30 in providing angled fastener insertion may further be enhanced by the concurrent utilization of a modified fastener 100, and modified striker 50 design, specifically adapted for canted securing of cabling or other wires. As shown in FIGS. 6, 7, and 9, a fastener 100 generally comprises a bight section 102 comprising a width extending between a pair of legs 104a, 104b, the legs extending outwardly from an underside of the bight section 102 at oblique angles. The bight section may be of a length sufficient to secure 12/2 and/or 12/3 MC cable, or cables of other variable sizes, as is known in the art. In some embodiments, the legs 104a, 104b are canted at a substantially forty degree angle (104a) and one hundred forty degree angle (104b), respectively, from the bight section 102; however, in other embodiments, the legs may be canted at other angles corresponding to the desired driving direction (DD) angle of the seating member 30 and/or the striker tip 54 (as detailed herein). At the bottom of each leg 104 is a distal endpoint 106. Each endpoint 106 may be designed to be sufficiently pointed, and/or sharpened, in an attempt to avoid any buckling of each leg 104 as it enters the target work piece, which may comprise any desired target that the fastener is to enter and secure to, such as, for example, wooden, plastic, concrete, or composite studs or planking.

In particular embodiments, the legs 104 will extend outwardly from the bight section 102 at oblique angles that terminate in endpoints 106 located on a plane running substantially parallel to the bight section 102 of the fastener 100. In this way, the fastener 100 may generally comprise the shape of an open-ended parallelogram. In certain embodiments, the shape may consist of a substantially open-ended rhombus parallelogram, while in other versions the shape may consist of a substantially rhomboid parallelogram. The shape of the fastener 100 and/or the driving direction (DD) may be generally configured so that the legs 104a, 104b substantially simultaneously contact the work piece side (WS), or in the alternatively approximately simultaneously contact, when the driving position (DP) is actuated to drive the fastener into the work piece (W). It is also understood that in approximately simultaneously contacting the work piece side (WS), the legs may not simultaneously contact the side of the work piece (WS), but rather almost contact simultaneously so that one leg contacts the work piece side while the second leg remains within 1/16 (or in other embodiments ⅛, ¼ or ½) of an inch above the work piece side (WS). Moreover, the fastener 100 design may permit the bight section 102 to be installed substantially parallel to a work piece side (WS) or to a substantially planar work piece surface (WS); although in some configurations the bight section 102 may be non-linear, or otherwise not parallel, compared to the work piece side (WS). In still other embodiments, the fastener 100 may comprise a driving flange 108 adapted to receive a more direct driving force from the striker 50.

As shown in FIGS. 6, 7, and 9, the striker 50 is at least partially shaped to correspond to the shape of the fastener 100 to ensure that sufficient driving forces are generated. Specifically, the striker 50 may have a striker tip 54 comprising an angled surface or leg adapted to substantially contact the top surface of a fastener bight section 102. In some embodiments, the striker tip 54 may have a recess cavity 56 adapted to deform the fastener 100 around the targeted cable (C) upon insertion of the fastener into the work piece (W). In still other embodiments, the striker tip 54 may comprise a striker pad 57 configured to apply driving forces to a driving flange 108 of the associated fastener 100. The driving tip may also comprise a striker notch 58 configured to substantially conform to, and apply direct driving forces to, the curved corner of an associated fastener 100.

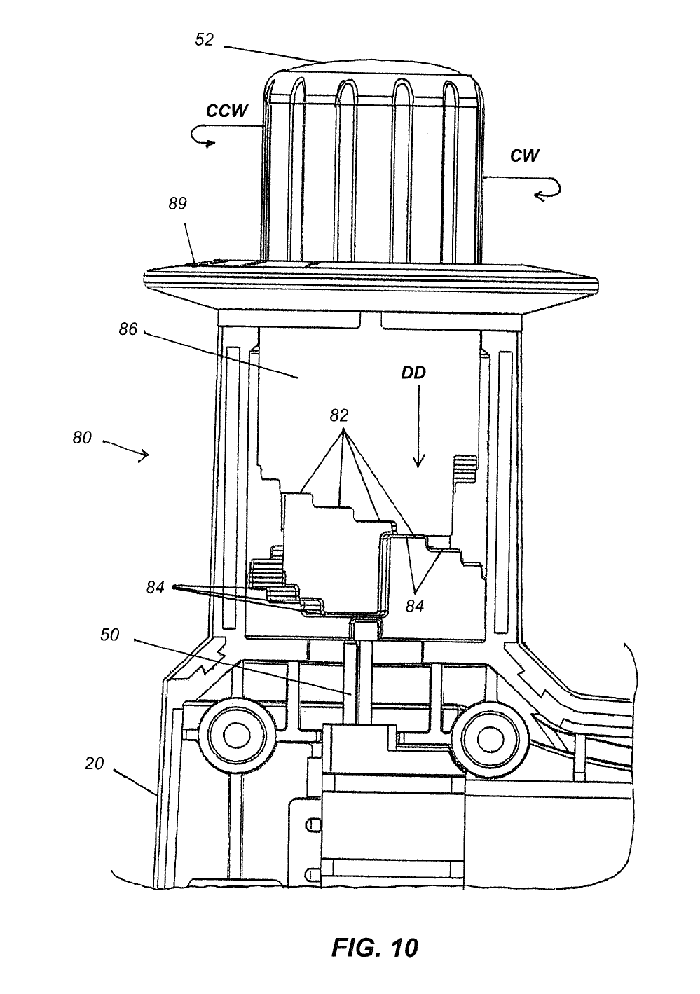

The driving tool 10 may also optionally comprise a stop member that is a depth adjustment mechanism 80 permitting a user to select a desirable depth of fastener 100 insertion into the work piece (W). As shown in FIGS. 10-16, the depth adjustment mechanism may comprise a rotary-style dial 86 that can be turned clockwise (CW) and counter-clockwise (CCW) to decrease or increase, respectively, the depth that an associated fastener 100 is driven into the work piece (W). Specifically, the depth adjustment mechanism 80 may be operatively attached to the striker 50 in a fashion that enables associated strike steps 82 and stop steps 84 to adjustably restrict movement of the striker 50 in the driving direction (DD).

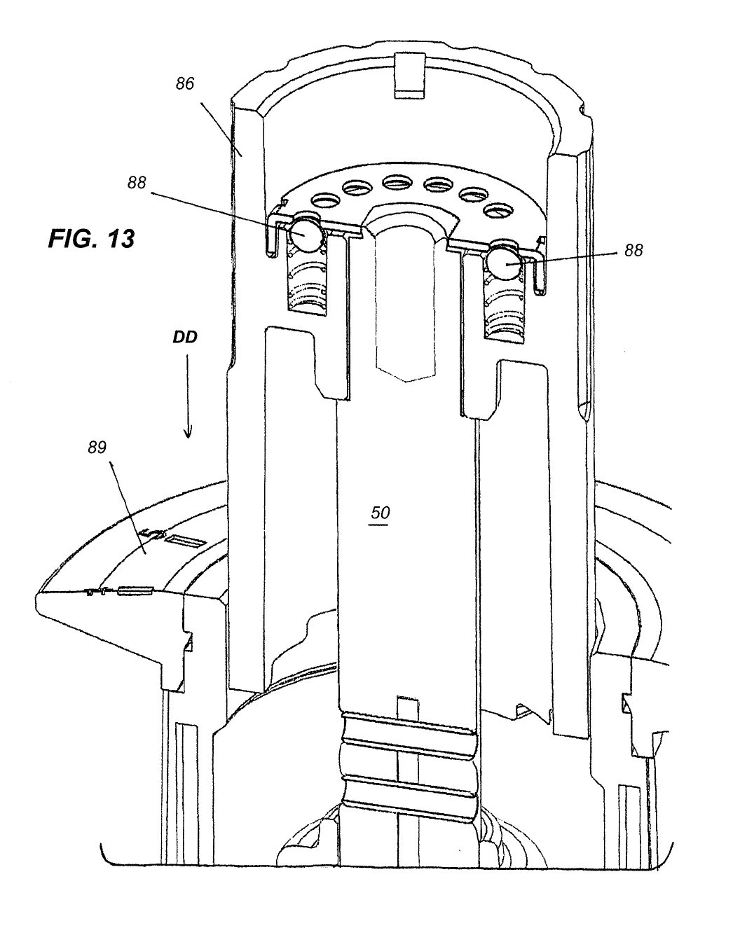

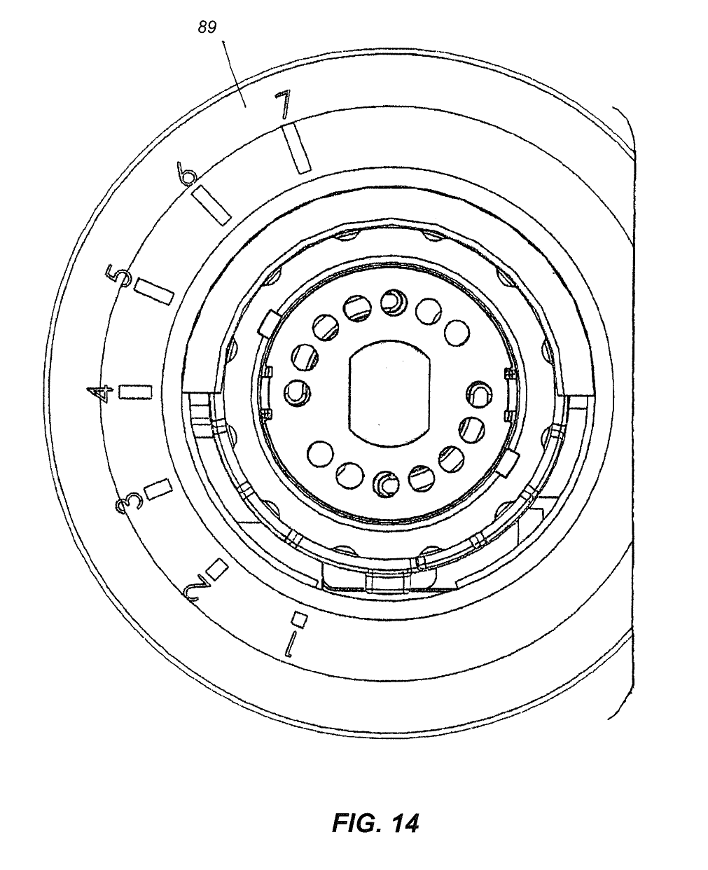

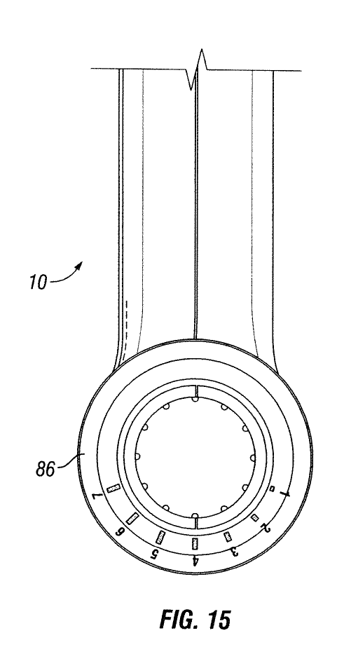

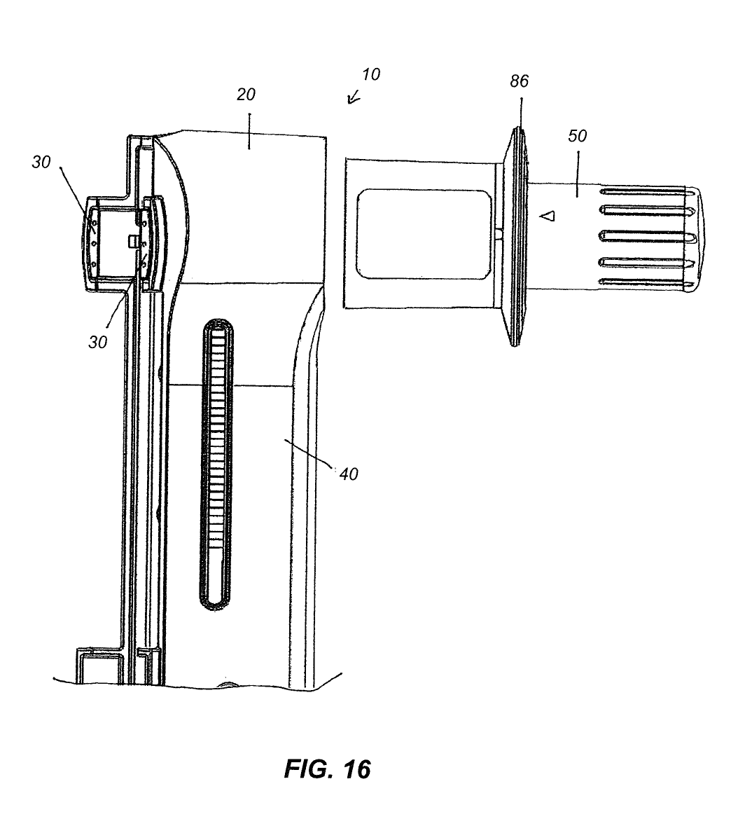

As can be appreciated with reference to FIG. 10, when the dial 86 terminating in strike steps 82 is rotated fully in a clockwise direction (CW), applying driving forces to the hammer plate 52 will move the striker 50 and dial 86 in the driving direction (DD) until the first in a series of escalating strike steps 82 contacts the first in a series of de-escalating stop steps 84. By turning the dial 86 counter-clockwise (CCW), spring biased action will rotate the lowest strike step 82 in a downward direction until it contacts the next stop step 84 in the aforementioned series of de-escalating stop steps 84, while simultaneously bringing the next strike step 82—in the series of escalating strike steps 82—into contact with the first stop step 82. Upon completion of a driving position movement (DP), spring biased action will then return the striker 50 and dial 86 to a resting position (RP) until a successive driving force actuates another driving position (DP) movement. This spring biased configuration can be seen in greater detail with reference to FIGS. 13 and 14, wherein spring biased ball bearings 88 permit controlled movement up or down the series of strike steps 82 and stop steps 84. Still further a depth gauge 89 may assist the user in identifying the appropriate fastener 100 driving depth. With reference to FIGS. 14 and 15, for example, the depth gauge may include indicia or other markings to identify a particular depths for selection.

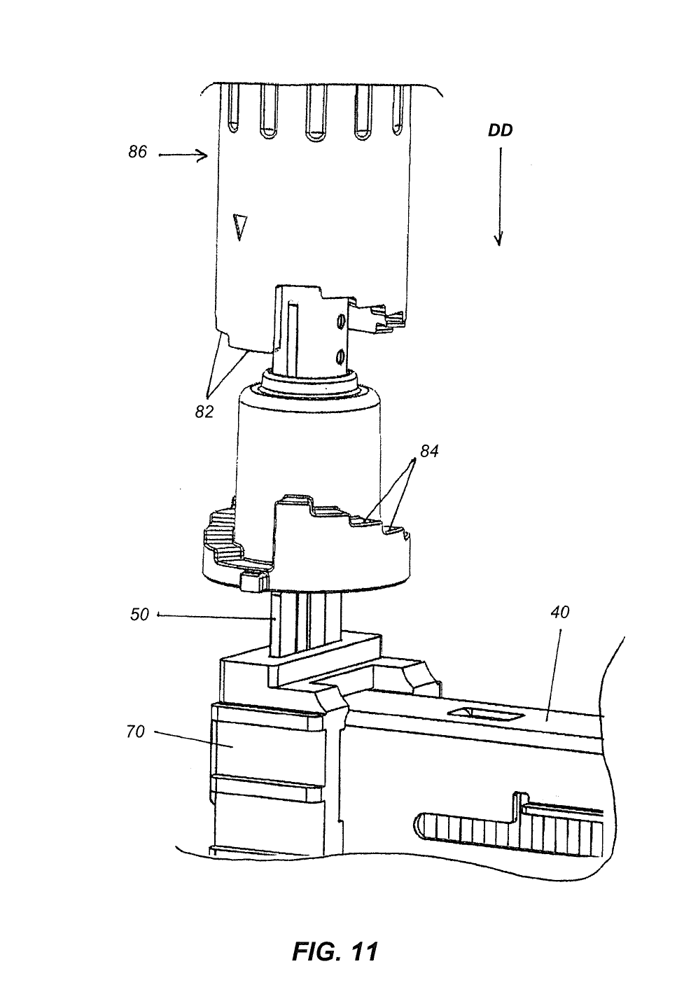

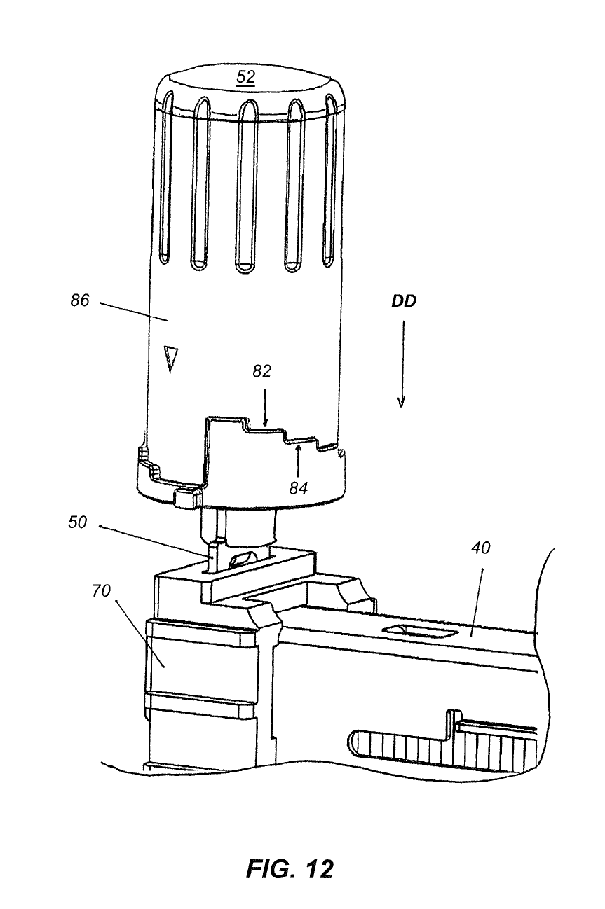

A person of ordinary skill in the art will understand that by rotating the dial 86 in clockwise and counter-clockwise directions the depth of fastener insertion into the work piece (W) can be controlled. In some embodiments, the seven different depth adjustments may be made in increments of 1/16 inch, with a driving action resulting in a fastener bight section 102 residing as little as ⅛ of an inch (minimum height) above the substantially planar work piece surface (WS), or with a fastener bight section 102 residing as much as ½ of an inch (maximum height) above the substantially planar work piece surface (WS). In other embodiments, however, the total number of adjustment increments could be changed, as could the height associated with an increment, to result in greater or lesser bight section heights. It can be appreciated that whatever the adjustment increments, or minimum and maximum bight section 102 height, in the above-described embodiment the fastener is driven to the maximum depth when the dial 86 is turned fully in the counter-clockwise direction (CCW)(FIGS. 11 and 12), and driven to its minimum bight section 102 height when turned fully in the clockwise direction (CW)(FIG. 10). In other versions, however, the configuration of strike steps 82 and stop steps 84 may be reversed to achieve the opposite result; with clockwise rotation increasing drive depth and counter-clockwise rotation reducing drive depth.

Modifications to the device components and arrangements detailed above can be made without departing from the scope of the invention. For example, in some embodiments the housing 20 may optionally include a sight window 24 permitting a user to visually gauge the number of fasteners 100 remaining before a refill is necessary. The manner in which the fastener magazine 40 is loaded and/or seated within the housing—bottom-loaded or end-loaded, as is well known in the art—may be modified. The size and capacity of the fastener magazine may be adjusted to cooperate with a particular housing design.

The devices described above are only examples of that apparatuses that may be employed to achieve the features and more general purposes of driving fasteners 100 into an associated work piece at oblique angles discussed above. Accordingly, the present invention also comprises methods of driving fasteners into a work piece at oblique angles whereby the above-described devices are but one of many devices capable of accomplishing the purpose of the invention. In one embodiment, however, a method for driving fasteners into a work piece at an oblique angle comprises, at least: providing a driving tool having: a seating member adapted to position fasteners in a driving direction obliquely angled above a side of a work piece; and a striker adapted to drive said fasteners into a work piece; positioning the seating member onto a work piece target zone at an oblique angle; and applying driving forces to the striker to drive the fastener into the work piece. Said method may be accomplished by grasping the driving tool about its housing, positioning the seating member onto an associated work piece target zone and applying driving forces to the striker. The method may include driving tool components permitting fasteners to be driven into an associated work piece in a driving direction comprising a substantially oblique angle relative to the associated substantially planar work piece.

In some embodiments of the above described methods the seating member may be integral to the housing, or the striker guide. In other embodiments, the seating member may include projections supported by the housing, or striker guide, said projections optionally including gripping protrusions for improved gripping of the work piece surface or tips having predefined seating angles.

In still other embodiments of the inventive methods, the driving tool is used in association with a staple having a bight section, the bight section having a width extending between a pair of legs, the pair of legs extending outwardly from an underside of the bight section at oblique angles. The legs may extend outwardly from the bight section at oblique angles that terminate in endpoints located on a plane running substantially parallel to the bight section of the fastener. Said fasteners may generally comprise the shape of an open-ended parallelogram, of either rhombus or rhomboid configuration, with legs configured to substantially simultaneously contact the work piece surface and be installed substantially parallel to a planar work piece surface.

In yet other embodiment of the inventive methods, the driving tool may additionally comprise a depth adjustment mechanism that permits a user to select a desirable depth of fastener insertion into the work piece.

In other versions of the method, various arrangements of disclosed driving tool components may be utilized to provide modified utility.

While this invention has been described with reference to particular embodiments thereof, it shall be understood that such description is by way of illustration and not by way of limitation. Accordingly, the scope and content of the invention are to be defined only by the terms of the appended claims.

What is claimed is:

1. A method for driving fasteners into a work piece at an angle, comprising:
providing a driving tool having:
a fastener;
a seating member adapted to position the fastener in a driving direction obliquely angled above a side of a work piece; and
a striker adapted to forcibly drive said fastener into the work piece side;
positioning the seating member onto a work piece target zone; and
applying a driving force to the striker to actuate insertion of the fastener into the work piece.

2. The method of claim 1, wherein the seating member is adapted to position the fastener at an oblique angle relative to the work piece.

3. The method of claim 2, wherein the seating member comprises two projections adapted to simultaneously engage the work piece at the target zone.

4. The method of claim 3, wherein the seating member additionally comprises gripping protrusions adapted to releasably grip the seating member onto the work piece.

5. The method of claim 3, wherein the length of the projections is adjustable.

6. The method of claim 1, wherein the driving tool additionally comprises a housing.

7. The method of claim 6, wherein the seating member is integral to the housing.

8. The method of claim 1, wherein the driving tool additionally comprises a magazine for containing fasteners.

9. The method of claim 1, wherein the driving tool additionally comprises a striker guide adapted to guide the striker in a driving direction and drive the fasteners out of the housing and into the work piece.

10. The method of claim 9, wherein the striker guide is integral to the seating member and adapted to position the housing at an oblique angle relative to the work piece.

11. The method of claim 2, wherein the fasteners comprise:
a bight section, the bight section having a width extending between a pair of legs; and
a pair of legs, extending outwardly from an underside of the bight section at oblique angles.

12. The method of claim 11 wherein the fastener legs have distal endpoints on a plane running substantially parallel to the bight section.

13. The method of claim 12, wherein:
the distal endpoints simultaneously contact and are inserted to the work piece; and,
the bight section is installed substantially parallel to a longitudinal span of the work piece.

14. A staple comprising:
a bight section, the bight section having a width extending between a pair of legs; and
a pair of legs, extending outwardly from an underside of the bight section at oblique angles.

15. The staple of claim 14, wherein the legs and bight form the shape of a substantially open-ended rhombus parallelogram.

16. The staple of claim 14, wherein the legs and bight form the shape of a substantially open-ended rhomboid parallelogram.

17. The staple of claim 14, wherein the fastener legs have distal endpoints on a plane running substantially parallel to the bight section.

18. The staple of claim 17 wherein the bight section additionally comprises a driving flange.

19. A fastener driving tool comprising:
a fastener;
a seating member adapted to position the fastener in a driving direction obliquely angled above a side of a work piece; and
a striker adapted to forcibly drive said fastener into the work piece side.
